(19) United States
(12) Patent Application Publication
(10) Pub. No.: US 2006/0089868 A1
(43) Pub. Date: Apr. 27, 2006

(54) System, method and computer program product for analyzing and packaging information related to an organization

(76) Inventors: Gordy Griller, Scottsdale, AZ (US); Renee Michael, Winchester, KY (US); Charles Byers, Lexington, KY (US); Vincent Fumo, Ventnor City, NJ (US); Joseph DiPrimio, Annapolis, MD (US); Moira Rowley, Kansas City, MO (US); Ingo Keilitz, Williamsburg, VA (US); Keith Robinson, Lexington, KY (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/974,432

(22) Filed: Oct. 27, 2004

(51) Int. Cl. G06F 17/30

(52) U.S. Cl. 705/10

(57) ABSTRACT

A computer-implemented method includes generating a graphical user interface (GUI). The GUI includes information related to an organization, and includes performance measures and a performance composite that are each associated with a value. The organization information, performance measure(s) and performance composite in the GUI include elements of an information hierarchy, each element of the information hierarchy being associated with one or more ascendant elements, sibling elements and/or descendant elements. The GUI includes a first portion that presents a selected element, and identifies and/or presents sibling element(s) of the selected element when the selected element is associated with sibling element(s). A second portion of the GUI identifies and/or presents ascendant element(s) of the selected element when the selected element is associated with ascendant element(s). And a third portion of the GUI identifies and/or presents descendant element(s) of the selected element when the selected element is associated with descendant element(s).

### FIELD OF THE INVENTION

The present invention generally relates to systems and methods for packaging and providing information, and more particularly relates to systems and methods for packaging hierarchically-related information and providing such information by means of a dynamically-created graphical user interface (GUI).

### BACKGROUND OF THE INVENTION

The proper metrics in evaluating the performance of an organization can drive world-class performance of that organization. Thus, performance measurement efforts have exploded in recent years at all levels of governments, as well as in private and non-profit organizations. Organizational performance measurement systems increasingly are seen not only as the best way to improve the quality of programs and services but also to drive major policy and organizational reform. Public “report cards” of organizations such as hospitals, nursing homes, schools and courts are helping citizens vote with their feet, their pocketbooks and their political support. They are also giving government agencies and organizations, and their stakeholders, incentives and the tools to look at themselves more closely and critically. Over the next few years, for example, individual courts and court systems may devote at least as much attention and as many resources to the development of automated court performance measurement systems as they have to caseflow management systems.

The ability to measure performance is a critical enabler for getting desired results and achieving performance goals. Performance measurement drives success. Performance measurement systems are commonplace in the private sector and are rapidly becoming accepted practice in the executive and legislative branches of government, as well as in the non-profit sector. Private companies and many public agencies outside court systems have found that an emphasis on a handful of vital performance measures linked to success factors will improve customer and citizen satisfaction, achieve gains in profits and other revenue, and make better workplaces for employees.

Organization leaders and managers know that trying to manage an organization without a simple guidance system is like trying to drive a car without a dashboard—like organizational management by occasional disasters—an apt metaphor increasingly used to introduce the critical function of performance measurement in strategic planning, management and leadership. When a driver starts the engine, the driver can see at a glance how much fuel is in the tank, the oil pressure, whether the lights are on and the doors properly closed. Once the car is moving, the speedometer not only alerts the driver to the car's speed but, in addition to the odometer, allows him or her to predict the time of arrival at his or her destination. The driver adjusts his or her driving continuously to accommodate the changing environment, driving conditions, rules of the road, and the performance information he or she gets from the gauges on the dashboard.

Central to this “dashboard” metaphor, as well as other metaphors such as the “balanced scorecard” and “performance report cards” is the development of a critical set of measures upon which performance of the organization may be based. Once these performance measures have been developed, however, organizations must still have a framework for monitoring, evaluating and using those measures to lead, plan and manage the organization. And while a number of different techniques have been developed to evaluate the performance of an organization based upon a number of performance measures, such techniques have drawbacks. Among these drawbacks, conventional techniques are typically computationally intensive and difficult to interpret. Thus, many conventional techniques also make it difficult for organization leaders and managers to monitor, evaluate and use such performance measures to efficiently and effectively lead, plan and manage their organizations.

### SUMMARY OF THE INVENTION

In light of the foregoing background, embodiments of the present invention provide an improved system, method and computer program product for analyzing and packaging information related to an organization. In accordance with embodiments of the present invention, organization information related to an organization can be imported, downloaded or otherwise received at one or more instances. From the organization information, then, one or more performance measures, as well as a performance composite, are automatically calculated. At least a portion of the organization information, performance measure(s) and performance composite can then be packaged in an easily-interpretable format, such as within a graphical user interface (GUI). A client can request and receive the packaged information which, including performance measures and/or performance composite, will be presented. From the packaged information, then, the client can evaluate the organization, or more particularly performance of the organization, in an easily interpretable manner that facilitates the client pinpointing the effects that various performance measures have on the overall performance of the organization, as represented by the performance composite.

According to one aspect of the present invention, a computer-implemented method is provided that includes generating a graphical user interface (GUI). The GUI includes information related to an organization (e.g., judicial court), at least one performance measure and a performance composite. In this regard, the performance measure(s) are associated with values calculated based upon the organization information, and the performance composite is associated with a value calculated based upon the performance measure value(s). The organization information, performance measure(s) and performance composite in the GUI include elements of an information hierarchy, each element of the information hierarchy being associated with one or more ascendant elements, sibling elements and/or descendant elements.

Advantageously, the GUI is generated such that the GUI includes at least three portions. The first portion of the GUI presents a selected element, and identifies and/or presents sibling element(s) of the selected element when the selected element is associated with sibling element(s). More particularly with respect to the selected element, for example, the first portion of the GUI can identify the selected element and include a value associated with the selected element, a change in the value associated with the selected element, and/or a symbol (e.g., green arrow, black diamond, red arrow, etc.) indicating if the value associated with the selected element has experienced a change. Further, the first portion of the GUI can include a graphical representation of the value associated with the selected element over a period of time, and/or a description of the selected element.

The second portion of the GUI identifies and/or presents ascendant element(s) of the selected element when the selected element is associated with ascendant element(s). In this regard, the second portion can identify ascendant element(s) of the selected element. For each identified ascendant element, then, the second portion can include a value associated with the ascendant element, a change in the value associated with the ascendant element, and/or a symbol indicating if the value associated with the ascendant element has experienced a change.

The third portion of the GUI identifies and/or presents descendant element(s) of the selected element when the selected element is associated with descendant element(s). For example, the third portion of the GUI can identify descendant element(s) of the selected element. For each identified descendant element, the second portion can include a value associated with the descendant element, a change in the value associated with the descendant element, and/or a symbol indicating if the value associated with the descendant element has experienced a change. Further, if so desired, the third portion can include, for at least one selected descendant element, a graphical representation of the value associated with the selected descendant element over a period of time, and/or a description of the selected descendant element.

In addition to generating the GUI, the method can include receiving the organization information, calculating the performance measure value(s) based upon the organization information, and thereafter calculating the quantitative performance composite value based upon the performance measure value(s). More particularly, the performance composite value may be calculated by weighting at least one performance measure value by an associated weighting factor. The performance measure value(s), including the weighted performance measure value(s), can then be aggregated into the performance composite value.

In one typical context, the organization information can include information related to a judicial court organization that may be associated with a plurality of cases scheduled for and/or disposed by the court, the plurality of cases being those before the court. In such instances, the performance measure value(s) relate to performance of the court, and the performance composite value relates to an aggregate performance of the court. More particularly, for example, the performance measure value(s) may be related to opinions of those persons associated with cases before the court, opinions of employees of the court, a cost per case before the court, a case record reliability, juror representation, restitution payments ordered by the court, and/or caseflow timeliness and efficiency.

The performance measure value related to caseflow timeliness and efficiency can, if so desired, be calculated by first calculating secondary performance measure values related to at least one of on-time case processing, case clearance, backlog clearance, and/or trial-date certainty. The secondary performance measure values can then be aggregated into the performance measure value related to caseflow timeliness and efficiency. Before aggregating the secondary performance measure values, however, one or more of the secondary performance measure values can be weighted by an associated weighted factor. The secondary performance measure values, including the weighted measure values, can then be aggregated into the performance measure value related to caseflow timeliness and efficiency.

According to other aspects of the present invention, a system and a computer program product are provided. The system, method and computer program product of embodiments of the present invention therefore enable monitoring of the performance of an organization in an easily-interpretable manner. As indicated above, and explained further below, the organization information, performance measure(s) and performance composite may be presented in the GUI in a hierarchical manner. By presenting the information in such a hierarchical manner, a piece of information may be presented along with pieces of information more closely positioned to the presented piece of information in an information hierarchy, and thus more closely related to the presented piece of information. Thus, not only are selected elements presented in an easily-interpretable manner, but the client or client user may more readily be directed to those closely-related piece(s) of information such that the organization information, performance measures and/or performance composite may be more readily interpreted by the client or client user. As such, the system, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for analyzing, packaging and presenting information, in accordance with an embodiment of the present invention;

FIG. 2 is a block diagram of an entity capable of operating as an information provider, service provider and/or client, in accordance with an embodiment of the present invention;

FIG. 3 is a flowchart illustrating various steps in a method of analyzing and packaging information, in accordance with one embodiment of the present invention;

FIG. 4a illustrates a graphical user interface (GUI) generated in accordance with one embodiment of the present invention;

FIG. 4b illustrates the GUI of FIG. 4a in the context of a judicial court organization; and

FIGS. 5-8 are exemplary GUI displays that may be presented during operation of an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

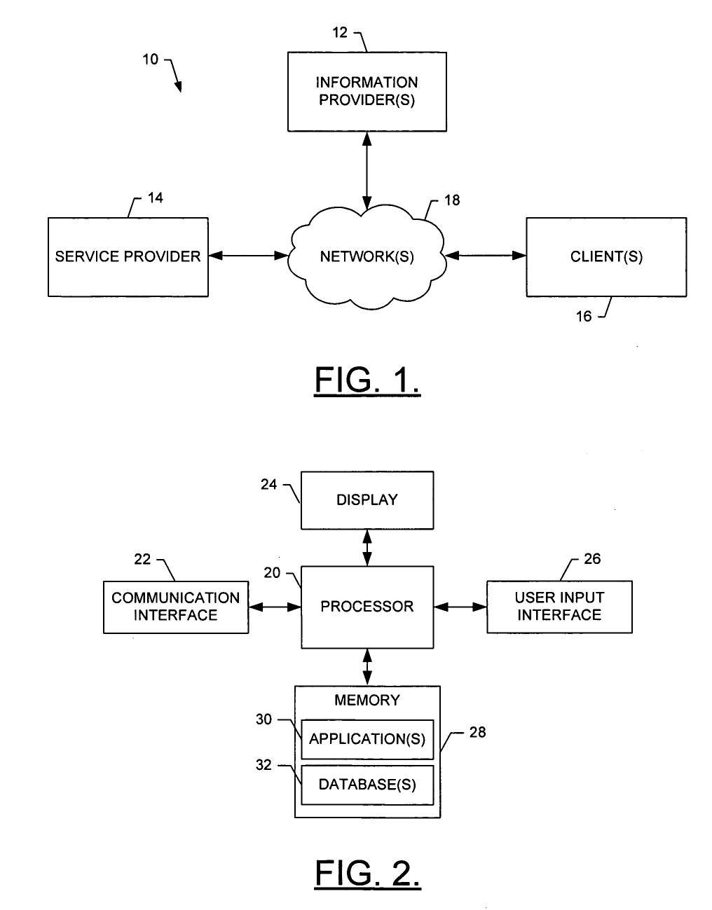

Referring to FIG. 1, a system 10 for analyzing, packaging and presenting information, such as hierarchically-related information, includes one or more information providers 12, service providers 14 and clients 16 (one of each being shown). Each information provider is capable of directly and/or indirectly communicating with one or more service providers. The service provider, in turn, is capable of directly and/or indirectly communicating with one or more clients. Similarly, each client may be capable of directly and/or indirectly communicating with the service provider, and the service provider may be capable of directly and/or indirectly communicating with one or more information providers. For example, the service provider can be capable of retrieving, from one or more information providers, various pieces of information related to an organization associated with a client. The service provider can then analyze and package that information for presentation by one or more clients in response to requests from the respective client(s) for such information.

The information provider 12, service provider 14 and client 16 can communicate in any of a number of different manners. For example, the information provider, service provider and client can communicate across one or more networks 18. The network(s) can comprise any of a number of different combinations of one or more different types of networks. For example, the network(s) can include one or more data networks, such as a local area network (LAN), a metropolitan area network (MAN), and/or a wide area network (WAN) (e.g., Internet), and include one or more wireline and/or wireless voice networks, including a wireline network such as a public-switched telephone network (PSTN), and/or wireless networks such as IS-136 (TDMA), GSM, GPRS, and/or IS-95 (CDMA). For purposes of illustration, however, as described below, the network comprises the Internet (i.e., WAN) unless otherwise noted.

The information provider 12, service provider 14 and client 16 can comprise any one or more of a number of different entities, devices or the like capable of operating in accordance with embodiments of the present invention. In this regard, one or more of the information provider, service provider and client can comprise, include or be embodied in one or more computer systems, such as one or more of a laptop computer, desktop computer, server computer or the like. Additionally or alternatively, one or more of the information provider, service provider and client can comprise, include or be embodied in one or more portable electronic devices, such as one or more of a mobile telephone, portable digital assistant (PDA), pager or the like. For example, the information provider, service provider and client can each comprise a processing element capable of communicating with one another across the Internet (e.g., network 18). It should be understood, however, that one or more of the information provider, service provider and client can comprise or otherwise be associated with a user carrying out one or more of the functions of the respective entity. Thus, as explained below, the term “information provider” can refer to an information provider and/or information provider user, and vice versa. Similarly, the term “service provider” can refer to a service provider and/or service provider user, and vice versa; and the term “client” can refer to a client and/or client user, or vice versa.

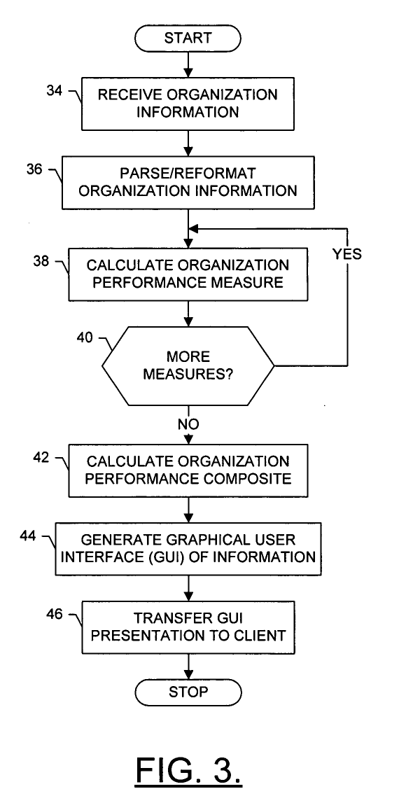

Referring now to FIG. 2, a block diagram of an entity capable of operating as an information provider 12, service provider 14 and/or client 16, as shown in FIG. 1, is shown in accordance with one embodiment of the present invention. Although shown as separate entities, in some embodiments, one or more entities may support one or more of an information provider, service provider and/or client, logically separated but co-located within the entit(ies). For example, a single entity may support a logically separate, but co-located, information provider and service provider. It should also be appreciated that one or more entities may be capable of performing one or more functions of one or more other entities. In this regard, an information provider may be capable of performing one or more functions of a service provider and/or client. Also, a service provider may be capable of performing one or more functions of an information provider and/or client. Additionally, or alternatively, a client may be capable of performing one or more functions of an information provider and/or service provider.

As shown, the entity capable of operating as an information provider 12, service provider 14 and/or client 16 generally includes a processor 20 connected to at least one interface or other means for displaying, transmitting and/or receiving data, content or the like. In this regard, the interface(s) can include at least one communication interface 22 or other means for transmitting and/or receiving data, content or the like via the network(s) 18, as well as at least one user interface that can include, for example, a display 24 and/or a user input interface 26. The user input interface, in turn, can comprise any of a number of devices allowing the entity to receive data from a user, such as an electronic scanner, keyboard, mouse and/or any of a number of other devices, components or the like capable of receiving data, content or the like.

In addition to the interfaces, the processor 20 can be connected to a memory 28. The memory can comprise volatile and/or non-volatile memory, and typically stores content, data or the like. In this regard, the memory typically stores software applications 30, instructions or the like for directing the processor to perform steps associated with operation of the entity in accordance with embodiments of the present invention. For example, as explained below, the memory can store software applications associated with the information provider, service provider and/or client, such as one or more Java™ applications. As explained below, when the entity comprises a service provider 14, the applications may be adapted to receive information from the information provider, analyze and package that information in an easily-interpretable format for the client 16. One or more client applications may then be adapted to request, receive and present the packaged data, such as for storage, analysis or the like.

In addition to applications 30, the memory 28 can also store one or more databases 32 of information. More particularly, when the entity comprises an information provider 12, the memory can store database(s) of information related to an organization associated with the client 16, such information hereinafter referred to as organization information. And as the service provider may be adapted to package information from the information provider, the service provider may likewise store database(s) of organization information. In addition, the service provider may store database(s) of one or more rules at least partially specifying the manner in which the service provider analyzes the organization information. Further, the service provider may store database(s) of packaged information, where the packaged information is at least partially based upon organization information received from the information provider.

Generally, in accordance with embodiments of the present invention, the service provider 14 is capable of importing, downloading or otherwise receiving from the information provider 12, organization information related to an organization associated with the client 16. The service provider may then analyze the organization information in accordance with one or more rules, resulting in the generation of one or more performance measures and/or a performance composite associated with the organization. As used herein, then, information may refer to one or more pieces of the organization information, performance measures and/or performance composite. At least a portion of the information can then be packaged in an easily-interpretable format. The client can request, receive and present the packaged information, including performance measures and/or the performance composite.

Based upon the presented information, then, the client 16 or more particularly the client user may better evaluate the organization, or more particularly performance of the organization, as well as evaluate the pieces of information that form the basis of the organization's performance. Advantageously, the service provider 14 may be adapted to periodically, at regular or irregular intervals, receive organization information or updated organization information from the information provider. At each instance of receiving the updated organization information, the service provider can analyze the updated organization information to thereby generate updated performance measures and/or performance composite. The updated organization information, performance measures and/or performance composite can then be packaged for presentation by the client. By periodically updating the organization information, performance measures and/or performance composite, the client user may therefore not only better evaluate the current performance of the organization, but may also evaluate a change in the performance of the organization from the current instance to a previous instance, and/or evaluate performance of the organization over a period of time.

Although the service provider 14 can package the information in any of a number of different manners, in one embodiment the service provider packages the information in a hierarchical manner within a graphical user interface (GUI). In this regard, as will be appreciated, the performance composite can be generated or otherwise calculated based upon the performance measures, and as such, the performance measures may be grouped or otherwise packaged underneath the performance composite such that at least two levels of the hierarchical structure are formed. Similarly, the performance measures can be generated or otherwise calculated based upon other performance measures and/or pieces of the organization information. Thus, other performance measures and/or pieces of organization information may therefore be grouped or otherwise packaged underneath respective performance measures to define additional levels of the hierarchical structure. Further, consider that one or more pieces of organization information may be based upon one or more other pieces of organization information. One or more piece(s) of organization information, then, may be grouped or otherwise packaged above or underneath other pieces of organization information to define still further levels of the hierarchical structure.

By packaging the information in a hierarchical manner, the packaged information can be presented in a manner easily-interpretable by the client 16 or client user. In this regard, a piece of information may be presented along with an identification and/or presentation of pieces of information more closely positioned to the presented piece of information in the information hierarchy, and thus more closely related to the presented piece of information, such as by supporting a higher level piece of information or being derived from a lower level piece of information. The pieces of information closely positioned to the presented piece of information can then be hyperlinked, and thus selectable, such that upon being selected, those closely-related piece(s) of information can be more particularly presented to the client user. Thus, not only is the presented element easily-interpretable by the client user, but the client user may more readily direct the client to those closely-related piece(s) of information such that the organization information, performance measures and/or performance composite may be more readily interpreted by the client user.

As will be appreciated, the organization associated with the client 16 can comprise any of a number of different organizations, with the information comprising any of a number of different pieces of information. For example, the organization can comprise a business organization, health care organization, educational organization or the like, with the information comprising qualitative and/or quantitative information related to different aspects of the organization. In one particularly advantageous embodiment described more particularly below, however, the organization comprises a judicial court. The organization information, then, can comprise qualitative and/or quantitative information related to cases scheduled for and/or disposed by the court, persons associated with the cases scheduled for and/or disposed by the court (i.e., cases before the court), and/or employees of the court, for example. The performance measures can comprise quantitative information related to the opinions of those persons associated with cases before the court, opinions of employees of the court, cost per case, case record reliability, juror representation and/or restitution payments ordered by the court. The performance measures can also include a juror representation index which, in turn, may include performance measures (i.e., performance measures grouped underneath the juror representation index in the information hierarchy) related to juror yield, juror voir dire, juror opinions of the court and/or juror race national origin. In addition, a performance measure may relate to caseflow timeliness and efficiency (CTE) index which, like the juror representation index, may include performance measures (i.e., performance measures grouped underneath the CTE index in the information hierarchy). The performance measures grouped underneath the CTE index, then, may relate to on-time case processing, case clearance, backlog clearance and/or trial-date certainty.

Although embodiments of the present invention are explained below in the context of a court organization with particular pieces of court information, performance measures and performance composite, it should be understood that, as indicated above, the organization can comprise any of a number of different organizations. Likewise, the information can comprise any of a number of different pieces of information.

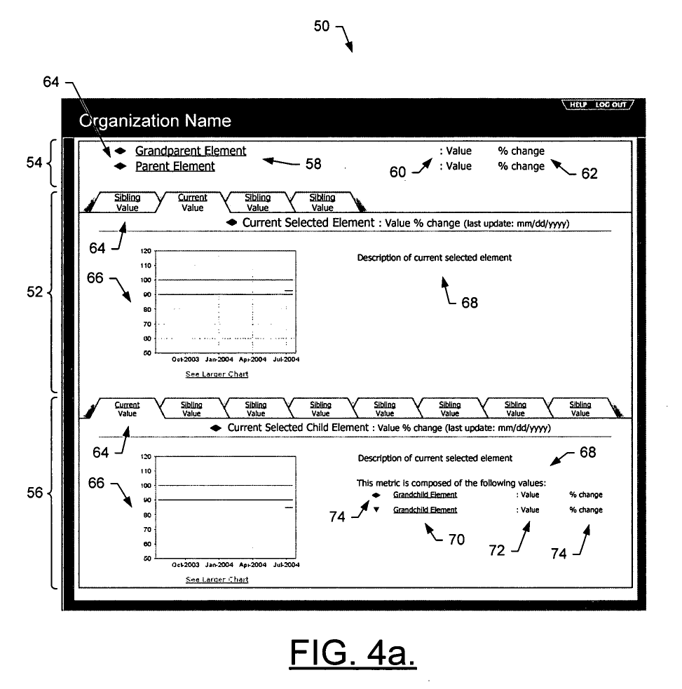

Reference is now made to FIG. 3, which illustrates various steps in a method of analyzing and packaging information, in accordance with one embodiment of the present invention. As shown in block 34, the method includes the service provider 14 receiving organization information from one or more information providers 12, such as across the network(s) 18. As indicated above, the organization information can comprise any of a number of different pieces of information related to an organization associated with a client 16. In this regard, when the organization comprises a judicial court, the organization information can comprise qualitative and/or quantitative information related to cases scheduled for and/or disposed by the court, persons associated with the cases scheduled for and/or disposed by the court (i.e., cases before the court), and/or employees of the court, for example. For example, judicial court organization information can include survey information from persons associated with cases before the court, survey information from employees of the court, as well as statistical and/or categorical information regarding different types of cases (e.g., criminal, civil, domestic relations, juvenile, etc.). More particularly, as explained below, judicial court organization information can include user opinion data, employee opinion data, cost data, case file data, juror data, restitution data, case processing data, case disposition data, backlog data and/or trial-date data.

Irrespective of the types of organization information received by the service provider 14, the service provider can thereafter store the organization information in database(s) 32 within memory 28 of the service provider. As will be appreciated, in various instances, the organization information may not be received in a format interpretable by the service provider, or may be received in different formats. For example, portions of the organization information may be received in a Microsoft® Excel format, Microsoft® Access format, ASCII text format, Hypertext Markup Language (HTML) format, Extensible Markup Language (XML) format and/or some other format. Thus, before or after storing the organization information, the service provider 14 may parse and/or reformat at least a portion of, if not all of, organization information, as shown in block 36.

More particularly, the service provider 12 may parse and/or reformat the organization information into different, identifiable pieces of organization information interpretable by the service provider, the pieces thereafter forming the basis of a number of performance measures, and thus a performance composite, of the organization. The organization information can be parsed and/or reformatted in any of a number of different manners. For example, the organization information can be parsed and reformatted into an XML format. As is well known to those skilled in the art, like HTML, XML uses tags to describe elements within a document, file or the like. Unlike in HTML, however, the tags in XML are not predefined, and as such, XML may be utilized to identify virtually any data item. Accordingly, XML permits marked-up organization information to function in a manner similar to a database record of such information.

Regardless of whether the service provider 14 parses and/or reformats the organization information, after receiving the organization information, the service provider can calculate one or more performance measures of the organization based upon one or more pieces of the organization information, as shown in blocks 38 and 40. Additionally, the service provider may calculate one or more performance measures of the organization based upon one or more other, calculated performance measures. Generally, the performance measures relate to the organization associated with the client 16, and are based upon at least a portion of the organization information received, and stored, by the service provider. In this regard, the performance measures may comprise any of a number of different measures of performance that can be determined, generated or otherwise calculated at least partly based upon the organization information.

As explained below, for example, the performance measures for a judicial court can include quantitative information related to core measures such as (a) the opinions of those persons associated with cases before the court (sometimes referred to as the “citizen/court user opinion” performance measure); (b) opinions of employees of the court (sometimes referred to as the “court employee opinion” performance measure); (c) the cost per case; (d) case record reliability; and/or (e) restitution payments ordered by the court (sometimes referred to as the “restitution” performance measure). A performance measure may also relate to a juror representation index core measure which, in turn, may include a number of secondary performance measures (i.e., performance measures grouped underneath the juror representation index in the information hierarchy) related to (1) juror yield, (2) juror voir dire, (3) juror opinions of the court, and/or (4) juror race national origin. In addition, a performance measure may relate to yet another core measure, caseflow timeliness and efficiency (CTE) index which, like the juror representation index, may include a number of secondary performance measures (i.e., performance measures grouped underneath the CTE index in the information hierarchy) related to (1) on-time case processing, (2) case clearance, (3) backlog clearance, and/or (4) trial-date certainty.

A. Citizen/Court User Opinion

Generally, the citizen/court user opinion performance measure relates to the percentage of citizen/court users providing favorable ratings to the court's accessibility, convenience, and treatment of the users (e.g., fairness, equality, courtesy, respect, etc.). The ratings can be provided in any of a number of different manners, but in one typical embodiment, the ratings are provided by means of surveys, questionnaires or the like. In this regard, citizen/users (e.g., litigants, attorneys, citizens seeking documents, witnesses, court employees, etc.) of the court on a typical day (i.e., a day considered generally representative of all “court” days) may be asked to complete a citizen/court-user questionnaire that includes a number of statements relating to the users' experience with the court. Each statement of the citizen/court-user questionnaire includes a number of ratings from which the users may select. The ratings, then, may represent different levels of agreement or disagreement with the statement (e.g., strongly agree, agree, no opinion, disagree, strongly disagree, not applicable). To facilitate analysis or subsequent use, the ratings may also be quantitatively represented (e.g., strongly agree=1, agree=2, no opinion=3, disagree=4, and strongly disagree=5). In this regard, the quantitative representations of the ratings may be configured such that the higher quantitative values correspond to more favorable ratings of the court's accessibility, convenience, and treatment of the users (e.g., fairness, equality, courtesy, respect, etc.).

In addition to the statement ratings, the citizen/court-user questionnaire may solicit information regarding the respondent. For example, the citizen/court-user questionnaire may solicit information such as the respondent's gender, formal education level and/or nationality, the frequency with which the respondent visits the court, the type of case or matter that brought the respondent to the court, and/or the involvement of the respondent in the respective case or matter. User opinion data collected by the citizen/court-user questionnaire, including the statement ratings and the information regarding the respondents, can then be received and stored by an information provider 12, such as into respective database(s) 32 in the memory 28 of the information provider. The organization information received by the service provider 14, then, may include the user opinion data. The service provider may then analyze at least a portion of the user opinion data.

For example, the service provider 14 can aggregate the ratings to some or all of the statements to yield one or more scores, such as by aggregating the ratings of all of the statements (higher scores typically corresponding to more favorable ratings) into the citizen/court user opinion performance measure. Because different groups of respondents (e.g., litigants, attorneys, citizens seeking documents, witnesses, court employees, etc.) may experience different problems, the ratings may differ for one or more groups. As will be appreciated, in lieu of the service provider performing all of the analysis, the information provider can perform at least a portion (or all) of the analysis, the results of which can thereafter be received by the service provider along with the other organization information.

B. Court Employee Opinion

Generally, the court employee opinion performance measure relates to the court employees' ratings of their knowledge and understanding, commitment, motivation and preparedness as such relate to their job responsibilities with the court. Like with the citizen/court user opinion performance measure, ratings for the court employee opinion performance measure can be provided in any of a number of different manners, including by means of surveys, questionnaires or the like. Court employees, including judicial officers and staff, may be periodically asked to complete a court-employee questionnaire that includes a number of statements relating to the employees' job-related experience with the court. Similar to the previously described citizen/court-user questionnaire, each statement of the court-employee questionnaire includes a number of ratings representing different levels of agreement or disagreement with the statement, with each rating being quantitatively represented (e.g., strongly agree=1, agree=2, no opinion=3, disagree=4, and strongly disagree=5). Also as before, the quantitative values may be configured such that the higher quantitative values correspond to more favorable ratings of the court employees' knowledge and understanding, commitment, motivation and preparedness.

Also like the citizen/court-user questionnaire, the court-employee questionnaire may also solicit information regarding the respondent. For example, the court-employee questionnaire may solicit information such as the court department or division within which the respondent works (e.g., civil, criminal, juvenile, family, probate, accounting, administration, judiciary, judicial support, pre-trial release, other, etc.), and/or the primary location of the respondent's job assignment (e.g., main courthouse, family court, satellite court #1, satellite court #2, etc.).

The data collected by the court-employee questionnaire, including the ratings and the information regarding the respondents, can then be received and stored by an information provider 12, such as into respective database(s) 32 in the memory 28 of the information provider. The organization information received by the service provider 14, then, may include employee opinion data that, in turn, includes the court-employee questionnaire and/or questionnaire data. The service provider may then analyze at least a portion of the employee opinion data.

For example, the service provider 14 can aggregate the ratings of some or all of the statements into one or more scores, such as by aggregating the ratings of all of the statements (higher scores typically corresponding to more favorable ratings) into the court employee opinion performance measure. Because employees working in different departments or divisions within the court may have different performance-related issues, the ratings may differ for one or more groups. Also as before, it should be appreciated that in lieu of the service provider performing all of the analysis, the information provider can perform at least a portion (or all) of the analysis, the results of which can thereafter be received by the service provider along with the other organization information.

C. Cost Per Case

As the name implies, the cost per case performance measure generally relates to the cost of judicial administration of cases before the court, and may be more particularly related to costs associated with different types of cases before the court. Thus, an information provider 12 can receive, at regular or irregular intervals, cost data related to total court costs or expenditures and case filings by case type (e.g., criminal, civil, domestic relations, juvenile, etc.). Generally, costs represent total expenditures for all court services and may include, for example, salaries (e.g., salary paid to employees of court administration, including judicial officers and all judicial support staff), juror costs, accommodation costs (e.g., actual rent or imputed rent on court owned or occupied land and buildings), information technology, departmental overheads, court operating expenses, and other expenditures (e.g., consultants, expert witnesses, mediators, interpreters, court security, accounting, human resources, training, and/or administration). Further, for example, in jurisdictions that include probation services as part of the court (instead of corrections), costs may also include that associated with probation services, although such a measure of cost may as much as double the cost value.

Having received the cost data, the information provider 12 can store such data in respective database(s) 32 in memory 28 of the information provider. The organization information received by the service provider 14, then, may include the cost data, which the service provider may then analyze. Alternatively, the information provider may perform at least a portion of the analysis, the results of which may be received by the service provider along with the other organization information. Irrespective of who performs the analysis, however, the cost per case performance measure can be calculated for one or more different types of cases by dividing the court's cost for the case type (e.g., total cost or one or more particular costs) by the number of cases filed for that case type. Additionally or alternatively, for example, a cost per case can be calculated for cases of one or more different types brought by a number of different courts (i.e., organizations), such as to establish baselines or control levels that can thereafter be compared against the cost per case for the respective court (i.e., organization associated with the client 16).

D. Case Record Reliability

As will be appreciated, courts often make and preserve readily accessible, accurate records of their proceedings, decisions, orders and judgments. Such records may include, for example, indexes, dockets, case information statements, and various registers of court actions maintained for purpose of inquiry into the existence, nature and history of actions at law. In addition, records may include documents associated with particular cases that make up official case files as well as the verbatim records of proceedings. And as will also be appreciated, court records are often stored or otherwise maintained at a number of different locations, and may have different levels of accuracy and completeness. Thus, the case record reliability performance measure generally relates to (a) whether files for cases before the court can be found and delivered on a timely and reliable basis and, once found, (b) whether the files meet criteria for accuracy and completeness (integrity).

Information upon which the case record reliability performance measure is based may be obtained in any of a number of different manners, but in one typical embodiment, the information is obtained from a review of at least a portion of the files of the court. For example, a random sample (e.g., fifty or more) of pending, closed-and-on-site, and closed-and-in-storage cases of one or more different types of cases may be selected. For each selected case, then, information on each case may be obtained including, for example, the location of the respective case file, length of time required to locate the file (including files in circulation). Thereafter, information regarding the condition and contents of the respective case file is obtained, such as by comparing the respective case file against entries in the case docket system for the respective case. A checklist of criteria relating to the accuracy and completeness of the case file can then be completed based upon the comparison.

Having received the case file data, including data relating to locating the file and the contents of the case file, the information provider 12 can store such data in respective database(s) 32 in memory 28 of the information provider. As with the other performance measures, the service provider can then receive organization information including the case file data, and perform an analysis of at least a portion of the case file data to determine, for example, the case record reliability performance measure. Alternatively, the information provider can perform at least a portion of the analysis, the results of which can be received by the service provider along with the other organization information.

More particularly, with respect to determining whether case files can be found and delivered on a timely and reliable basis (see (a) above), case file data for each case type can be used to determine the percentage of case files located within a specific time (e.g., within ten minutes of request). For off-site files, however, the specific time may be set longer than that for on-site case files (e.g., one working day). With respect to determining whether located files meet criteria for accuracy and completeness (see (b) above), the percentage of case files meeting specified integrity criteria by major case type may be determined from the checklists of integrity criteria. If so desired, the percentage of case files meeting at least a predetermined number of integrity criteria can also be determined, those case files identified as meeting established criteria of accuracy and completeness. The case record reliability performance measure can then be expressed as a single value, namely, the percentage of case files found on time that meet the established criteria of accuracy and completeness. And as will be appreciated, the overall case record reliability can be expressed as a number of values that vary based upon, for example, case type and integrity criteria.

E. Restitution

The restitution performance measure generally relates to how well a court takes responsibility for the enforcement of its orders in terms of the amount of restitution moneys collected and the timeliness of its disbursement to victims. A secondary yet important aim of this measure is evaluating the efficiency of the court's internal processes for collecting and distributing monetary penalties. The restitution performance measure may be based on three data elements: total restitution payments ordered by a court; the total payments actually dispersed to recipients of such payments (e.g., victims, family members, and/or other third parties including, for example, employers, insurers, victim compensation programs, government entities, victim service agencies, etc.); and the elapsed time between the date of the order and the date of disbursement of payments. Thus, the restitution performance measure may be expressed as the proportion of the monetary restitution ordered by a court that is actually dispersed by a court within established timelines.

With respect to the restitution performance measure, an information provider 12 can receive, at regular or irregular intervals, restitution data related to the total amount of restitution payments ordered in a given time period (e.g., a month, quarter, year, etc.) and the total amount of on-time restitution payments made to payment recipients in that same time period. In this regard, a payment may be referred to as being made “on-time” if the respective disbursement to the recipient is made by the due date for the receipt of payment by the payor plus an amount of time (e.g., five court days) allotted for receipt, processing, and disbursement of the payment. Restitution data can be obtained, for example, from a court automated information system (or an information provider can comprise such a system), and/or from court records or other documents including information. Moreover, restitution data can include information such as court case number, date of order/sentence, total restitution amount, payment due date(s), bookkeeping agency record number, date of first payment, date(s) of other payments, total number of payments, total paid, total amount of disbursements by recipient type, and/or date of disbursements (by type).

Having received the restitution data, as before, the information provider 12 can store such data in respective database(s) 32 in memory 28 of the information provider. From the information provider, the service provider 14 can receive organization information including the restitution data, which the service provider can analyze. Alternatively, the information provider can at least partially analyze the restitution data, and provide the results of such to the service provider along with the other organization information.

More particularly, for example, the restitution performance measure can be calculated for one or more different types of cases, the restitution effectiveness being representative of the amount of restitution payments actually disbursed on time. In this regard, the restitution effectiveness can be expressed as a proportion or percentage of the total amount of restitution payments ordered by the court in a given period of time. In addition to determining the restitution effectiveness for the court, a restitution effectiveness can be determined for cases of one or more different types brought by a number of different courts (i.e., organizations), such as to establish baselines or control levels. As before, then, the organization information received by the service provider 14 with respect to restitution may include the restitution data, and/or the analysis performed on the cost data (or such analysis can be performed by the service provider).

F. Juror Representation Index

As indicated above, the juror representation index may include a number of performance measures related to, for example, (1) juror yield, (2) juror voir dire, (3) juror opinions of the court, and/or (4) juror race national origin. Each such performance measure will now be separately explained. Before explaining performance measures upon which the juror representation index may be based, the juror representation index itself will be briefly explained. Generally, the juror representation index relates to citizens summoned to serve as jurors, and those citizens ultimately selected as jurors. The juror representation index can be calculated by the service provider 14 based upon a number of other performance measures calculated by the service provider (or information provider(s) 12) which, in turn, are based upon organization information from one or more information providers.

Generally, the juror representation index is calculated as an aggregate of the quantitative performance measures that make up the juror representation index. As will be appreciated, however, in various instances, one or more of the performance measures that make up the juror representation index may have more importance to the client 16 than one or more other of the performance measures that make up the juror representation index. Thus, before aggregating the respective performance measures into the juror representation index, one or more of the respective performance measures may be multiplied by a weighting factor. The weighted performance measures may then be aggregated with the other respective performance measures to calculate the juror representation index.

The weighting factors of the respective performance measures can be assigned by any of a number of different network entities (e.g., information provider 12, service provider 14, and/or client 16), and be assigned in any of a number of different manners that express an importance of the performance measures with respect to one another (those performance measures making up the juror representation index). More particularly, the weighting factors can be selected such that all of the weighting factors total 100% (i.e., 1.00), with the weighting factors assigned based upon relative importance and numbered from 0.01 to 1.00. For example, weighting factors for the performance measures making up the juror representation index as indicated above and explained below may be assigned as follows: (1) weight (WY) assigned juror yield, WY=0.17; (2) weight (WVD) assigned to voir dire, WVD=0.17; (3) weight (WJO) assigned to juror opinions of the court, WJO=0.17; and (4) weight (WRNO) assigned to juror race national origin, WRNO=0.49. In such a weighting assignment, it can be shown that juror race national origin may be considered the most important performance measure making up the juror representation index, while the other performance measures may be considered equally important, but less important than juror race national origin.
(1) Juror Yield

The juror yield performance measure generally relates to the percent of citizens summoned for jury duty who are qualified and actually available to server as a juror in a case before the court. In this regard, juror yield compares the number of citizens summoned for jury duty who are qualified and actually available to serve as a juror, to the overall number of citizens summoned for jury duty by the court. In this regard, juror data, upon which the juror yield performance measure is based, may be obtained in any of a number of different manners, but in one typical embodiment, the juror data is obtained from a court automated information system (or an information provider 12 can include such a system), and/or from a review of at least a portion of the cases before the court. For example, juror data can include data such as the number of qualified citizens (e.g., over eighteen years of age, etc.) summoned to serve as jurors, or be available to serve as jurors, for a period of time; the number of qualified citizens summoned during a previous period who postponed service to the current period; the number of qualified citizens summoned and then notified not to report for service. In addition, for example, juror data can include the number of citizens expected to report for jury duty who are otherwise unavailable to serve, including those citizens who do not report as instructed, those citizens sent undeliverable summons, those citizens postponing service to a subsequent period, as well as those citizens disqualified, excused or otherwise exempt from serving as jurors.

After receiving the juror data, the information provider 12 can store such data in respective database(s) 32 in memory 28 of the information provider. As with the other performance measures, the service provider 14 can then receive organization information including the juror data, and perform an analysis of at least a portion of the juror data to determine, for example, the juror yield performance measure. Alternatively, the information provider can perform at least a portion of the analysis, the results of which can be received by the service provider along with the other organization information.

More particularly, the total number of citizens available to serve as jurors can be determined by summing the number of summons sent by the court for the current period and the number of citizens who postponed service to the current period, and subtracting the number of citizens notified not to report for service from that sum. Similarly, the total number of citizens unavailable to serve as jurors from those otherwise expected to report can be determined by summing the number of citizens who do not report as instructed, the number of citizens sent an undeliverable summons, the number of citizens postponing service to a subsequent period, and the number of citizens disqualified, excused or otherwise exempt from serving as jurors. The total number of citizens unavailable to serve as jurors can then be subtracted from the total number of citizens available to serve as jurors, with the difference thereafter divided by the total number of citizens available to serve as jurors to calculate the ratio of citizens summoned for jury duty who are qualified and actually available to server as a juror in a case before the court. The juror yield can then be calculated by expressing the ratio as a percentage.
(2) Juror Voir Dire

The juror voir dire performance measure generally relates to the percent of jurors participating in voir dire compared to the total number of citizens reporting and in attendance for jury duty. Thus, an information provider 12 can receive, at regular or irregular intervals, jury data that includes, the total number of citizens reporting and in attendance for jury duty, and of those in attendance, the number of citizens participating in voir dire. After receiving such juror data, the information provider 12 can store such data in respective database(s) 32 in memory 28 of the information provider. The organization information received by the service provider 14, then, may include this juror data, which the service provider may then analyze. Alternatively, the information provider may perform at least a portion of the analysis, the results of which may be received by the service provider along with the other organization information.

Irrespective of who performs the analysis, however, the juror voir dire performance measure can be calculated based upon the juror data. More particularly, for example, the juror voir dire performance measure can be calculated by first calculating the ratio of number of citizens in reporting and in attendance for jury duty who are also participating in voir dire, by the total number of number of citizens in reporting and in attendance for jury duty. The juror voir dire can then be calculated by expressing the ratio as a percentage.
(3) Juror Opinion

The juror opinion performance measure, similar to the citizen/court user opinion performance measure, relates to the percentage of jurors providing favorable ratings to the court's accessibility, convenience, and treatment of the jurors (e.g., fairness, equality, courtesy, respect, etc.). Thus, also similar to the citizen/court user opinion performance measure, the ratings can be provided by means of surveys, questionnaires or the like, such as in the same manner explained above with respect to the citizen/court user opinion performance measure. Juror data for the juror opinion performance measure, including data collected by a juror questionnaire, including statement ratings and information regarding the respondents, can then be received and stored by an information provider 12, such as into respective database(s) 32 in the memory 28 of the information provider. The organization information received by the service provider 14, then, may include such juror data. The service provider may then analyze at least a portion of the juror data, such as to calculate the juror opinion performance measure.

For example, the service provider 14 can aggregate the ratings to some or all of the statements of a juror questionnaire to yield one or more scores, such as by aggregating the ratings of all of the statements (higher scores typically corresponding to more favorable ratings) into the juror opinion performance measure. Like the citizen/court user opinion performance measure, in lieu of the service provider performing all of the analysis, the information provider can perform at least a portion (or all) of the analysis, the results of which can thereafter be received by the service provider along with the other organization information.
(4) Juror Race National Origin

The juror race national origin performance measure relates to representation of minority groups in jury pools selected by the court. In this regard, juror race national origin represents a comparative parity, expressed as a percentage, between the representation of minority groups in the population of citizens in the jurisdiction of the court, and the same groups in a final jury pool of citizens selected by the court. An information provider 12 can therefore receive, at regular or irregular intervals, juror data additionally or alternatively including the racial makeup of the geographic area corresponding to the court's jurisdiction, and the racial and national origin makeup of the jury pools assembled by the court. The racial and national origin makeup of the area of the court's jurisdiction may be obtained in any of a number of different manners, but in one typical embodiment, such information is obtained from census information. Similarly, the racial and national origin makeup of the jury pools may be obtained in any of a number of different manners, such as from juror qualification questionnaires or summonses, and/or questionnaires distributed to prospective jurors.

Thus, juror data related to the juror race national origin performance measure can include, for example, a statistical population for the racial and national origin makeup of those citizens, in the jurisdiction of the court, qualified to serve as jurors. For example, from census information, a statistical population can be determined to include 66.9% Caucasian, 28.5% African American, 2% Hispanic, 1.8% Asian, 0.1% Native Hawaiian or other Pacific Islander, 0.7% of an “other” race or national origin, and 1.6% without a reported race or national origin. Then, if so desired, one or more of the more prevalent minority categories (e.g., African American, Hispanic, Asian, etc.) may be selected from the races and national origins represented in the statistical population.

Also, for example, the juror data related to the juror race national origin performance measure can include statistical samples of the percentages of citizens of different minority categories in the overall jury pools. In this regard, those citizens forming the jury pools can include those citizens who report for jury duty and are qualified to serve as jurors, those citizens also having a reportable race or national origin. For example, from a jury pool of 256 citizens, from among the more prevalent minority categories, 49 of those citizens may be African American (19.1% of the pool), 4 may be Hispanic (1.6% of the pool), and 2 may be Asian (0.80% of the pool).

After receiving the juror data related to the juror race national origin performance measure, the information provider 12 can store such data in respective database(s) 32 in memory 28 of the information provider. As with the other performance measures, the service provider 14 can then receive organization information including such juror data, and perform an analysis of at least a portion of the juror data to determine, for example, the juror race national origin performance measure. Alternatively, the information provider can perform at least a portion of the analysis, the results of which can be received by the service provider along with the other organization information. Irrespective of who performs the analysis, however, to more particularly calculate the juror race national origin performance measure, a minority parity for one or more minority categories (e.g., more prevalent minority categories) may be calculated by calculating a minority disparity (expressed as a percentage), and recasting the disparity as a minority parity by subtracting the minority disparity from 100%. In this regard, the minority disparity can be calculated by subtracting the statistical sample for the minority category by the statistical population for the minority category, dividing the difference by the statistical population for the minority category, and expressing that ratio as a percentage. Continuing the above example, then, the disparity for African Americans can be calculated as 33% (i.e., [(28.5%−19.1%)/28.5%]×100). Changing the disparity to parity requires subtracting the above disparity value (33%) from 100% resulting in a parity value of 67%. Then, after calculating the minority parit(ies), the juror race national origin performance measure can be calculated by reducing the minority parit(ies) into a single minority parity, such as by calculating the mean of the minority parit(ies). The mean minority parity, then, can be considered the juror race national origin performance measure.

As indicated above, the juror representation index may be calculated based upon the juror race national origin performance measure, that performance measure being calculated from minority parit(ies). As will be appreciated, the performance measures, including juror race national origin, are typically arranged such that improved performance of the organization is suggested by an increase in one or more of the performance measures, or otherwise an increase in the performance composite based upon the performance measures. It should be understood, however, that in addition to calculating minority parit(ies), minority disparit(ies) may also be calculated and included in the organization information, although the juror race national origin, and thus, the representation index, is typically based upon the minority parit(ies). In such instances, like in the case of the minority parit(ies), an additional disparity performance measure can be calculated, and included in the organization information, by reducing the minority disparit(ies) into a single minority disparity, such as by calculating the mean of the minority disparit(ies).

G. CTE Index

As indicated above, the CTE index may include a number of performance measures related to, for example, (1) on-time case processing, (2) case clearance, (3) backlog clearance, and/or (4) trial-date certainty. Each such performance measure will now be separately explained. Before explaining performance measures upon which the CTE index may be based, the CTE index itself will be briefly explained. Generally, the CTE index relates, as the acronym CTE suggests, to caseflow timeliness and efficiency. The CTE index can be calculated by the service provider 14 based upon a number of other performance measures calculated by the service provider (or information provider(s) 12) which, in turn, are based upon organization information from one or more information providers.

Generally, the CTE index is calculated as an aggregate of the quantitative performance measures that make up the CTE index. As will be appreciated, like the juror representation index, in various instances, one or more of the performance measures that make up the CTE index may have more importance to the client 16 than one or more other of the performance measures that make up the CTE index. Thus, before aggregating the respective performance measures into the CTE index, one or more of the respective performance measures may be multiplied by a weighting factor, with the weighted performance measures thereafter being aggregated with the other respective performance measures to calculate the CTE index.

The weighting factors of the respective performance measures can be assigned by any of a number of different network entities (e.g., information provider 12, service provider 14, and/or client 16), and be assigned in any of a number of different manners that express an importance of the performance measures with respect to one another (those performance measures making up the CTE index). More particularly, the weighting factors can be selected such that all of the weighting factors total 100, with the weighting factors assigned based upon relative importance and numbered from 1 to 100. For example, weighting factors for the performance measures making up the CTE index as indicated above and explained below may be assigned as follows: (1) weight (WT) assigned on-time case processing, WT=25; (2) weight (WC) assigned to case clearance, WC=35; (3) weight (WB) assigned to backlog clearance, WB=25; and (4) weight (WTC) assigned to trial-date certainty, WTC=15. In such a weighting assignment, it can be shown that case clearance may be considered the most important performance measure making up the CTE index, while trial-date certainty may be considered the least important such performance measure.
(1) On-Time Case Processing

The on-time case processing performance measure generally relates to the length of time required to process court cases. In this regard, on-time case processing compares case processing times to local, state or national guidelines, and represents a degree of compliance with such guidelines. As such, the on-time case processing performance measure can be expressed as the percentage of cases reaching the first and final outcome (i.e., resolved, disposed or concluded) within established timeframes. This performance measure can be calculated from case processing information collected from cases before the court that have reached the first and final outcome.

Case processing data, upon which the on-time case processing performance measure is based, may be obtained in any of a number of different manners, but in one typical embodiment, the case processing data is obtained from a court automated information system (or an information provider 12 can include such a system), and/or from a review of at least a portion of the cases before the court that have reached the first and final outcome. For example, a random sample (e.g., 300 or more) of cases may be selected from among those cases that have been disposed or concluded by the court, the cases being of one or more different types of cases. As will be appreciated, case disposition or conclusion—first and final outcome—may be defined differently for the various case types. For example, the disposition date in civil protection order or protection from abuse cases, for example, is defined as the date on which a protection order is granted (after trial or consent of parties) or denied (after trial), or the date on which the petition is dismissed. The disposition date in criminal cases, on the other hand, may be defined as the date on which all charges for the case are disposed.

For each selected civil case, for example, case processing data can include data such as case number, plaintiff name, case type (e.g., child support, protection from abuse, custody, divorce/annulment, etc.), complaint filing date, first answer filing date, last at-issue memorandum filing date, date the case was assigned to an arbitrator, date a trial was requested after arbitration, verdict date, other disposition date, number of trial settings, type of disposition (e.g., default/default judgment, dismissal, summary judgment, settled, arbitration award, court trial, etc.), and/or date of disposition. For each criminal case, on the other hand, case processing data can include data such as court case number, defendant's name, most serious criminal charge, number of felony charges, original arrest date, first court appearance date, date indictment/information filed or bind-over from lower court (whichever occurs first), date of arraignment on indictment/information, date of disposition, date of sentencing, number of trial settings, and/or type of disposition.

After receiving the case processing data, the information provider 12 can store such data in respective database(s) 32 in memory 28 of the information provider. As with the other performance measures, the service provider 14 can then receive organization information including the case processing data, and perform an analysis of at least a portion of the case processing data to determine, for example, the on-time case processing performance measure. Alternatively, the information provider can perform at least a portion of the analysis, the results of which can be received by the service provider along with the other organization information.

More particularly, the time from filing of a case to the disposition (i.e., first and final outcome) of that case can be determined for the selected cases of different types. The time-to-disposition data can then be summarized by the number and percentage of cases disposed within specified time frames. The summarized time-to-disposition data can then be compared to local or state case processing time standards (e.g., 12 months for general civil cases), with the on-time case processing performance measure calculated as the proportion of cases disposed within the respective time standards. For example, consider a court that disposed of 10,000 general civil cases in a given year, but only 8,970 of those cases were within a standard time frame of 12 months. In such an instance, the on-time case processing performance measure may be expressed as 0.90 (i.e., ˜8,970/10,000).
(2) Case Clearance

The case clearance performance measure generally relates to how well the court keeps up with its incoming caseflow. Thus, an information provider 12 can receive, at regular or irregular intervals, case disposition data including, for one or more different types of cases, the number of cases filed for a given time period (e.g., day, week, month, quarter, year, etc.), as well as the number of cases disposed in that time period. After receiving the case disposition data, the information provider 12 can store such data in respective database(s) 32 in memory 28 of the information provider. The organization information received by the service provider 14, then, may include the case disposition data, which the service provider may then analyze. Alternatively, the information provider may perform at least a portion of the analysis, the results of which may be received by the service provider along with the other organization information.

Irrespective of who performs the analysis, however, the case clearance performance measure can be calculated for one or more different types of cases by dividing the number of cases of the respective case types disposed by the total number of cases filed for that case type. Additionally or alternatively, for example, a case clearance can be calculated for cases of one or more different types brought by a number of different courts (i.e., organizations), such as to establish baselines or control levels that can thereafter be compared against the case clearance for the respective court (i.e., organization associated with the client 16).
(3) Backlog Clearance

The backlog clearance performance measure generally relates to evaluating the age of cases awaiting disposition by the court, the age being evaluated to determine whether a case backlog exists and, if so, to determine its magnitude in terms of workload. With respect to the backlog clearance performance measure, then, an information provider 12 can receive, at regular or irregular intervals, backlog data including, for one or more different types of cases, the number of currently pending cases, as well as the types of cases, and the filing dates or ages of the cases. After receiving the backlog data, the information provider 12 can store such data in respective database(s) 32 in memory 28 of the information provider. The organization information received by the service provider 14, then, may include the backlog data, which the service provider can analyze. Alternatively, the information provider may perform at least a portion of the analysis, the results of which may be received by the service provider along with the other organization information.

Irrespective of who performs the analysis, however, the backlog data can be compared to local or state case processing time standards for the maximum time typically required to dispose of the respective types of cases. Those cases having an age exceeding the maximum time standards, are identified as being backlogged by the court, with the remaining cases identified as being timely cases. The backlog clearance performance measure can then be calculated as the ratio of the number of timely cases to the total number of timely and backlogged cases.

As will be appreciated by those skilled in the art, reliance on gross caseload (e.g., filings), may mask significant differences in actual activity and workload. Caseload measures typically do not take into account the different amounts of resources and attention required of different case types. Thus, in accordance with an alternative embodiment, the case backlog clearance performance measure can be calculated by performing a judicial workload assessment with respect to the backlogged cases. More particularly, the backlog clearance performance measure can be calculated by first establishing a “weighted caseload” for cases of the different types. That is, the different types of cases can be multiplied by backlog weighting factors assigned to express an amount of resources and attention required by the different case types with respect to one another. The backlog clearance performance measure of this alternative embodiment can then be calculated by aggregating the weighted caseloads of the different case types, and translating the aggregate weighted caseload into a workload measure, such as the full-time equivalent (FTE) judge/staff required to remove the backlog. Alternatively, the weighted caseloads can be translated into the workload measure, with the workload measures of the different types of cases aggregated into the backlog clearance performance measure.

The case backlog clearance performance measure of this alternative embodiment enhances the traditional input measure of pending caseload backlog (i.e., the proportion of all pending that exceed the time standards), by instead representing a workload backlog expressed in terms of the FTE judge/staff required to remove the backlog. For example, assume that a court has 500 pending felony cases exceeding the time standards of one year from filing to disposition, and that felony cases have a backlog weighting factor of 300 minutes. In such an instance, the weighted caseload for felony cases can be calculated as 15,000 minutes (i.e., 500×300 minutes). The weighted caseload for felony cases can then be aggregated with the weighted caseload for the other types of cases. The backlog clearance performance measure can then be calculated by expressing the aggregate weighted caseload as an FTE judge/staff by dividing the aggregate weighted caseload by a judge/staff “year” of 60,000 minutes available to process cases.
(4) Trial-Date Certainty

The trial-date certainty performance measure generally relates to how often cases scheduled for trials, including for example, jury trials, non-jury trials, adjudicatory hearings in juvenile cases, and trials on petitions to terminate parental rights, are scheduled before such trials are actually conducted. In this regard, trial-date certainty represents the frequency with which cases scheduled for jury trial are actually conducted when scheduled, which may be compared against a desired number or standard number of trial settings. The standard number of trial settings, then, can correspond to an acceptable number of times the court, on average, schedules trials before those trials are actually conducted.

An information provider 12 can therefore receive, at regular or irregular intervals, trial-date data for cases disposed during or at the conclusion of trial during a given time period (e.g., week, month, quarter, year, etc.). Trial-date data may be obtained in any of a number of different manners, but in one typical embodiment, the trial-date data is obtained from a court automated information system (or an information provider can include such a system), and/or from a review of at least a portion of the cases before the court that have reached the first and final outcome. For example, a random sample (e.g., 300 or more) of cases may be selected from among those cases disposed during or at the conclusion of trial during the given time period. As will be appreciated, the cases may be of one or more different types of cases, and may involve trials of one or more different types of trials.

Generally, a “trial” may be defined as a hearing at which the parties contest the facts in the case and present evidence before a judge in open court, and in which the judge or jury renders a decision that results in an entry of judgment in the case. For purposes of simplicity in measurement, however, there may be certain kinds of events that, while often dispositive, are not be referred to as “trials.” For example, a hearing on a motion for summary judgment, a contested omnibus hearing or suppression hearing, and/or a default or show cause hearing may not be considered critical events. In this regard, a summary judgment hearing may not be considered a trial because the parties agree on the facts, with appropriate application or interpretation of the law being the only issue resolved at such a hearing. A contested omnibus hearing or suppression hearing may not be considered a critical event because such hearings may or may not be dispositive, thereby preventing one from determining beforehand whether such hearings will result in the entry of a judgment. In contrast, a trial on a petition to terminate parental rights is typically considered a trial.

Thus, trial-data can include, for one or more different types of cases and different types of trials (e.g., jury trial, non-jury trial, adjudicatory hearing in a juvenile case, trial on a petition to terminate parental rights, etc.), the number of trial settings made with respect to the cases (including the trial setting from which the trial was actually conducted). For each type of trial, the percentage of cases requiring different numbers of trial settings (1, 2, 3, etc.) can also be identified, as can the median and average number of trial settings. The percentage, median and average can then be included in the trial-date data. After receiving the trial-date data, the information provider 12 can store such data in respective database(s) 32 in memory 28 of the information provider. As with the other performance measures, the service provider 14 can then receive organization information including the trial-date data, and perform an analysis of at least a portion of the trial-date data to determine, for example, the trial-date certainty performance measure. Alternatively, the information provider can perform at least a portion of the analysis, the results of which can be received by the service provider along with the other organization information.

As indicated above, trial-date certainty represents the frequency with which cases scheduled for jury trial are actually conducted when scheduled, which may be compared against a desired number or standard number of trial settings. Thus, to more particularly calculate the trial-date certainty performance measure, a trial certainty quotient may be calculated to identify the number of trial settings divided by the number of trials actually conducted based upon those trial settings. For example, if a court conducted 100 trials in a given year that had to be scheduled a total 278 times (including the time the trials were actually conducted), the trial certainty quotient could be calculated as 2.78 (i.e., 278/100). Then, after calculating the trial certainty quotient, the trial-date certainty performance measure can be calculated by dividing the desired number or standard number of trial settings by the trial certainty quotient. For example, presume the standard number of trial settings is set at 2.0. In such an instance, the trial-date certainty performance measure can be calculated as 0.72 (i.e., 2.0/2.78).

Referring again to FIG. 3, regardless of what performance measure(s) of the organization the service provider 14 calculates, and how the service provider calculates those performance measure(s), the service provider can thereafter calculate an organization performance composite based upon the calculated performance measure(s), as shown in block 42. In this regard, the performance composite may be considered an overall, aggregate measure of performance of the organization associated with the client 16. As explained herein, then, the performance composite for a judicial court may be referred to as a court performance index (CPI). Although the performance composite can be calculated by the service provider 14 in any of a number of different manners, the CPI is generally calculated as an aggregate of at least a portion of the quantitative performance measures previously calculated by the service provider (e.g., citizen/court user opinion, court employee opinion, cost per case, case record reliability, juror representation, restitution, CTE index, etc.).

As with the juror representation index and the CTE index, however, in various instances, one or more of the performance measures that make up the performance composite (e.g., CPI) may have more importance to the client 16 than one or more other of the performance measures that make up the performance composite. Thus, before aggregating the respective performance measures into the performance composite, one or more of the respective performance measures may be multiplied by a weighting factor. The weighted performance measures may then be aggregated with the other respective performance measures to calculate the performance composite.

The weighting factors of the respective performance measures can be assigned by any of a number of different network entities (e.g., information provider 12, service provider 14, and/or client 16), and be assigned in any of a number of different manners that express an importance of the performance measures with respect to one another (those performance measures making up the performance composite). More particularly, like in the case of the CTE index explained above, the weighting factors can be selected such that all of the weighting factors total 100, with the weighting factors assigned based upon relative importance and numbered from 1 to 100. For example, weighting factors for the performance measures making up the performance composite as indicated above may be assigned as follows: (a) weight (WUO) assigned citizen/court user opinion, WUO=10; (b) weight (WEO) assigned to court employee opinion, WEO=10; (c) weight (WCC) assigned to cost per case, WCC=15; (d) weight (WRR) assigned to case record reliability, WRR=15; (e) weight (WJR) assigned to juror representation, WJR=15; (f) weight (WR) assigned to restitution, WR=10; and (g) weight (WCTE) assigned to the CTE index, WCTE=25. In such a weighting assignment, it can be shown that the CTE index may be considered the most important performance measure making up the CPI.

Irrespective of how the performance composite is calculated, the service provider 14 can thereafter package the organization information, performance measures and/or performance composite in an easily-interpretable format. More particularly, the service provider can package the information by generating a graphical user interface (GUI) that permits access to the organization information, performance measures and/or performance composite, as shown in block 44. As indicated above, in accordance with one typical embodiment of the present invention, the organization information, performance measures and/or performance composite is packaged for display via the GUI in a hierarchical manner. The information can therefore be packaged such that, while presenting a selected piece of information, the pieces of information more closely positioned to the presented piece of information in the information hierarchy, and thus more closely related to the presented piece of information, may also be presented or otherwise identified.

As explained herein, the organization information, performance measures and/or performance composite may be referred to as elements in an information hierarchy. Within the information hierarchy, then, an element may have one or more ascendant elements positioned above the element within the information hierarchy, one or more sibling elements positioned at the same level as the element within the information hierarchy, and/or one or more descendant elements positioned below the element within the hierarchy. For example, the performance composite may have descendants including the performance measures (children elements), and underneath the performance measures, other performance measures and/or organization information (grandchildren elements). The performance measures may have ascendants including the performance composite and possibly other performance measures (parent and/or grandparent elements), sibling elements including other performance measures, and descendants including organization information, and possibly other performance measures (children elements) and further organization information (grandchildren elements). And organization information may have ascendants including the performance composite (grandparent element), performance measures and possibly other organization information (parent elements), siblings including other organization information, and possibly descendants including other organization information.

Generally, then, the organization information, performance measures and/or performance composite can be packaged such that, for each presented element of the information hierarchy, the GUI not only presents the respective element, but also identifies and/or presents one or more ascendant elements, sibling elements and/or descendant elements of the presented element. For each presented element, then, the GUI may also present one or more elements more closely positioned to the presented element in the information hierarchy. Additionally or alternatively, the GUI may identify one or more ascendant, sibling and/or descendant elements more closely positioned to the presented element such that the GUI may be directed to present those ascendant, sibling and/or descendant elements by selecting the respective, identified elements. Thus, in accordance with embodiments of the present invention, not only is the presented element easily-interpretable by the client user, but the GUI may more readily direct the client to those piece(s) of information, and thus more closely related to the presented piece of information.

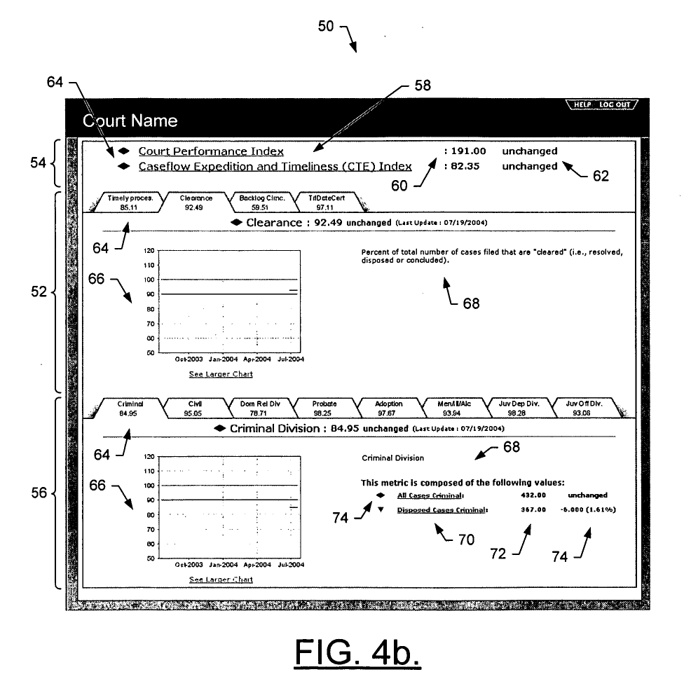

Reference is now made to FIGS. 4a and 4b, which illustrate an exemplar GUI 50 generated by the service provider 14 in accordance with one embodiment of the present invention, and more particularly illustrate such an exemplar GUI in the context of a judicial court organization as explained above. As shown, the elements of different levels of the information hierarchy may be included in different portions of the GUI, thereby representing the relative positions of the elements within the information hierarchy. For example, a current selected element (e.g., case clearance performance measure) may be presented in a first, or typically middle, portion 52 of the GUI, while ascendant elements (e.g., CPI and CTE index) are identified or otherwise presented in a second, or typically top, portion 54 of the GUI, and descendent elements (e.g., types of cases upon which the case clearance performance measure is based) are identified or otherwise presented in a third, or typically bottom, portion 56 of the GUI.

As shown, the top portion 54 of the GUI 50 may identify one or more ascendant elements 58 of the element selected in the middle portion 52. For each identified ascendant element, the top portion of the GUI may identify a value 60 (e.g., performance measure) associated with the ascendant element, and/or a percentage change 62 (or absolute change) in the value from a previous updating of the value. Further, for easier reference to elements experiencing a change, the GUI may further include a symbol 64 indicating if the value has experienced a positive change (e.g., green arrow pointing upward), no change (black diamond), or negative change (e.g., red arrow pointing downward). Further, the ascendant elements may also be selectable, such as by means of hypertext links. Thus, upon being selected, the GUI can alter the different portions of the GUI such that the selected ascendant element is presented in the middle portion along with its respective sibling elements, and such that its respective ascendant elements are identified or otherwise presented in the top portion, and its descendant elements are identified or otherwise presented in the bottom portion 56 of the GUI.

The middle portion 52 of the GUI 50 therefore presents the current selected element (e.g., case clearance performance measure), and may also identify or otherwise present sibling elements of the current selected element. In this regard, the selected element, as well as the sibling elements, may be presented in the middle portion by means of selectable tabs 64 that identify the respective elements, and also identify values (e.g., performance measure) associated with the respective elements. By selecting a tab for an element, the GUI presents a number of different pieces of information associated with the selected element. For example, the GUI may identify the selected element, the value associated with the selected element, as well as a percentage change in the value from a previous updating of the value, and the date upon which the value was last updated. The GUI may also present a graphical representation 66 of the value associated with the selected element over a period of time, as well as a description 68 of the current selected element.

As indicated above, the bottom portion 56 of the GUI 50 identifies or otherwise presents descendent elements (e.g., types of cases upon which the case clearance performance measure is based) of an element selected in the middle portion 52 of the GUI. Similar to the middle portion, the bottom portion may present a selected descendant element (e.g., criminal division or case type), and may also identify or otherwise present sibling elements of the current selected descendant element. Also similar to the middle portion, the selected descendant element, as well as its sibling elements, may be presented in the bottom portion by means of selectable tabs 64 that identify the respective elements, and also identify values (e.g., performance measure) associated with the respective elements. Again, by selecting a tab for a descendant element, the GUI presents a number of different pieces of information associated with the selected descendant element. For example, the GUI may identify the selected descendant element, the value associated with the selected descendant element, as well as a percentage change in the value from a previous updating of the value, and the date upon which the value was last updated. The GUI may also present a graphical representation 66 of the value associated with the selected descendant element over a period of time. Further, also as similar to before, the GUI may present a description 68 of the current selected descendant element.

As will be appreciated in various instances, the current selected descendant element in the bottom portion 56 of the GUI may, in turn, have one or more descendants in the information hierarchy. In such instances, the GUI may further include one or more additional portions for presenting such descendants. Additionally or alternatively, the GUI may identify, along with the description of the current selected descendant element, one or more descendant elements 70 of the current selected descendant element, those descendants 70 also being descendants of the current selected element in the middle portion 52 of the GUI. For each descendant element identified in the description of the current selected descendant element, the GUI may identify a value 72 associated with the descendant element, a percentage change 72 (or absolute change) in the value from a previous updating of the value, and/or a symbol 74 indicating if the value has experienced a positive change, no change, or negative change. The descendant elements may also be selectable, such as by means of hypertext links. Thus, upon being selected, the GUI can present information related to the selected descendant elements.

Again referring to FIG. 3, after generating the GUI 50 of the organization information, performance measures and/or performance composite (see block 44), at one or more points in time the service provider can transfer the GUI (including the packaged organization information, performance measures and/or performance composite) to the client 16 associated with the organization upon which the respective information is based, as shown in block 46. The GUI can be transferred in any of a number of different manners. For example, the GUI can be transferred to the client across the network(s) 18 at regular or irregular intervals, or otherwise upon request by the client. Upon receiving the GUI, then, the client can present the GUI to a client user, such as by means of the client display 24. The client and/or client user can then utilize the GUI, and/or the packaged organization information, performance measures and/or performance composite, in one or more of a number of different manners. For example, the client user can utilize the GUI to evaluate the organization based upon the information presented by the GUI. From such an evaluation, then, the client user may facilitate management of the organization, such as in a manner that increases the performance measures and, thus, the performance composite.

Also, as indicated above, to permit the client 16 or client user to continuously evaluate the organization, the service provider 14 may be adapted to periodically, at regular or irregular intervals, receive organization information or updated organization information from the information provider(s) 12. The service provider can analyze the updated organization information to thereby generate updated performance measures and/or performance composite. The service provider can then generate or otherwise update the GUI based upon the updated organization information, performance measures and/or performance composite. The updated GUI can then be transferred to the client during the next instance of transferring a GUI to the client. Thus, the client or client user may not only better evaluate the current performance of the organization, but may also evaluate performance of the organization over a period of time.

It should further be understood that the GUI 50 can, if so desired, implement one or more levels of security to restrict access one or more pieces of the organization information, performance measures and/or performance composite. In this regard, the GUI can be configured such that a client 16, or more particularly a client user, must be authorized to access the elements presented by the GUI, such as by providing a username and password to the GUI before the GUI presents elements of the information hierarchy. The GUI can be further configured to implement multiple levels of security such that different client users are authorized to access different elements of the information hierarchy. In such instances, the level of security afforded a client user may be identifiable based upon the username/password provided by the client user. For example, the GUI may be configured to provide access to higher-level elements of the information hierarchy in response to receiving a username/password from a lower-level court employee. On the other hand, the GUI may be configured to provide access to all of the elements of the information hierarchy, including the higher-level elements and lower-level elements, in response to receiving a username/password from a court manager, judge or other higher-level court employee.

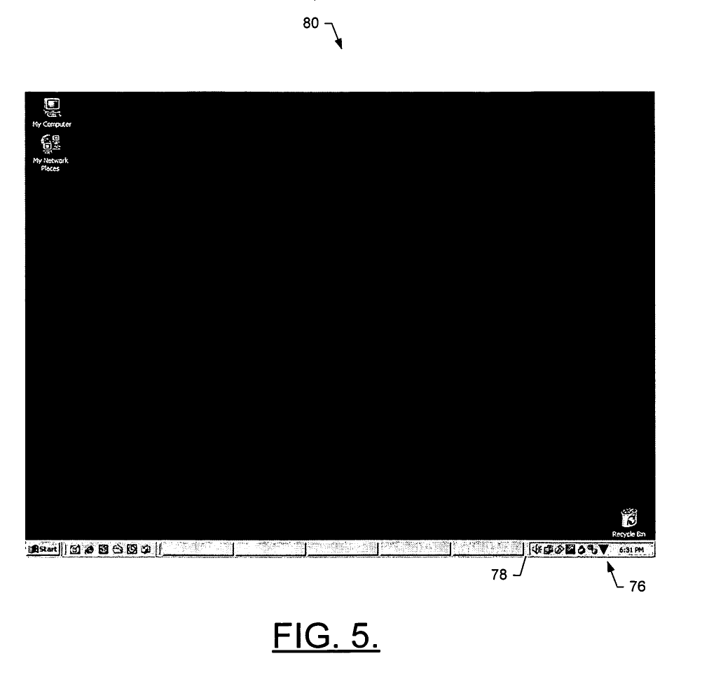

To further illustrate benefits of embodiments of the present invention, reference is now made to the exemplary GUI shown in FIGS. 5-8. Although a more particular description of an exemplary embodiment of the present invention will be described below, it will be understood that the below-described embodiment is but one example embodiment of the present invention, and should therefore not be taken to limit the scope of the present invention. It will further be understood that the GUI shown in FIGS. 5-8 (as well as the GUI of FIGS. 4a and 4b) are also merely exemplary GUIs of those that could be generated by the service provider 14 during operation of embodiments of the present invention, and should likewise not be taken to limit the scope of the present invention.

Consider a court manager, judge or other employee (i.e., client) who logs onto the court's Web site via the user's computer (i.e., client 16). On a portion of the court's Web site is positioned a field including a court performance summary represented as a single value, as well as a change of that value from a previous measure. That is, a field of the court's Web site includes the current CPI value of the court, accompanied by a green arrow, black triangle or red arrow (i.e., symbol), and/or a number, indicating whether the CPI is up or down from the previous day and by what percentage, and/or by how many points.

Alternatively, consider a court manager, judge or other employee who configures an application (i.e., application 30) on the user's computer to present a symbol 76 (i.e., green arrow, black triangle or red arrow) indicating whether the CPI of the court is up or down from the previous day. As shown in FIG. 5, the green arrow, black triangle or red arrow can be presented in the taskbar 78 on the desktop 80 of the operating system of the user's computer.

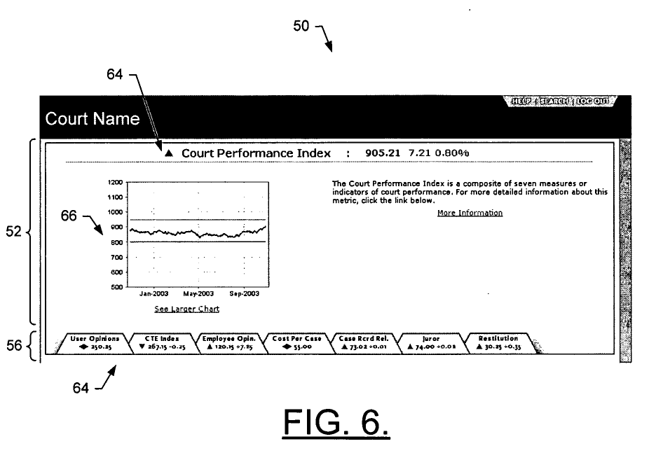

In either event, by selecting the window of the court's Web site or the symbol, the court manager, judge or other employee can quickly access information upon which the CPI is based. The information is functionally presented by the GUI as a “balanced scorecard” of core performance measures or indicators (components) upon which the CPI is based. More particularly, as shown in FIG. 6, the user can access at least a portion of a GUI (e.g., middle portion 52 of the GUI 50) that presents the court's CPI, the absolute and percentage differences between the current CPI and yesterday's CPI, as well as the symbol representation of any change in the CPI. In addition, the GUI presents a graph (i.e., graphical representation 66) of the CPI over a period of time, as well as a description 68 of the CPI. In addition, the GUI can present, underneath the CPI, selectable tabs 64 (e.g., in bottom portion 56) that identify performance measures upon which the CPI is based, as well as values and symbols for those performance measures indicating any change in the respective values.

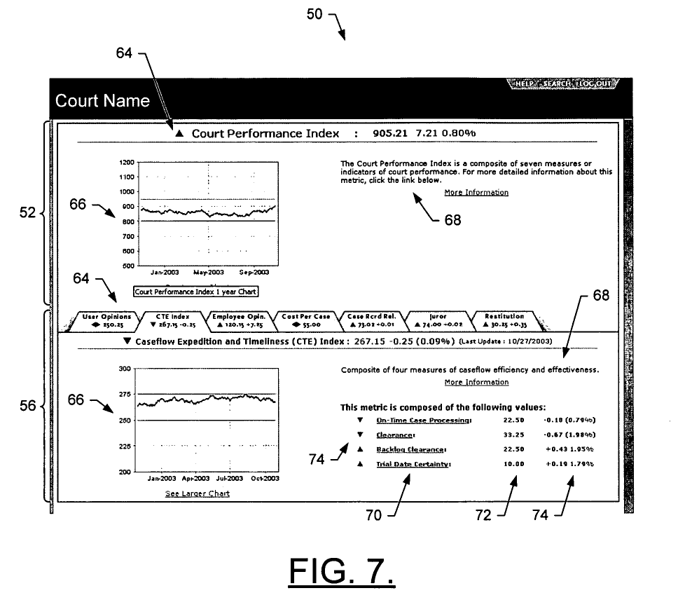

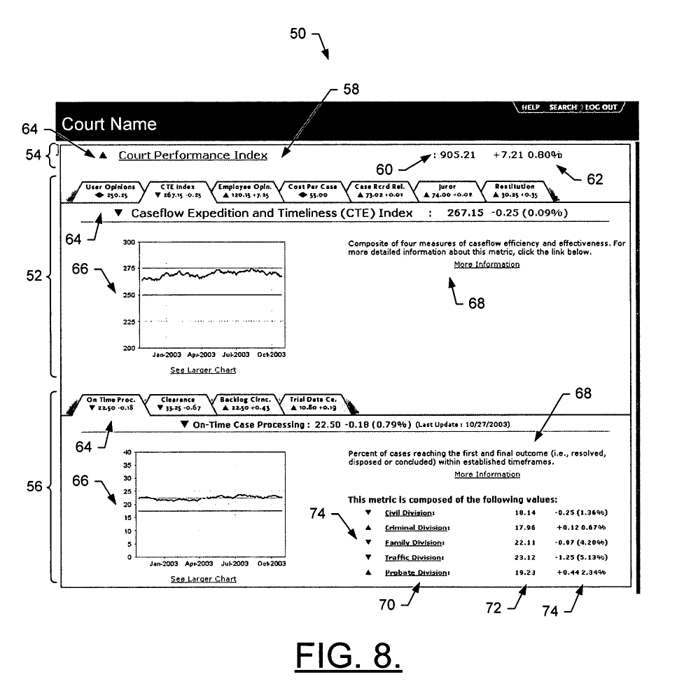

Thus, with a few selections of elements of the GUI 50, and by “dropping down” through several displays of the GUI presenting progressively more detailed and less aggregated data, the user can more particularly pinpoint the court, division, case type or resources (i.e., organization information) needing attention, and get clues about corrective actions, as shown in FIGS. 7 and 8. Such GUI displays of an automated court performance measurement system provide, in a matter of seconds or a few minutes, the critical functions of performance measurement: (1) identifying current performance (establishing baselines); (2) ascertaining trends; (3) determining boundaries or tolerances (setting controls); (4) diagnosing problem areas: and (5) supporting planning efforts (prediction and forecasting).

From the GUI 50 in FIG. 6, the user quickly discovers, for example, that one of the measures, the CTE index, is down from the previous day. By selecting the tab 64 for the CTE index, another portion or presentation of the GUI reveals a graph (i.e., graphical representation 66) of the CTE index over time, shown in FIG. 7. In addition, the user discovers that, within the CTE index, two other performance measures, on-time case processing and case clearance, are actually responsible for dragging down the court's CPI. To further pinpoint the root of the decrease in CPI, then, the user selects a hyperlink associated with on-time case processing, thereby directing the GUI to present further information related to the on-time case processing measure, shown in FIG. 8. From the GUI presentation of FIG. 8, then, the user learns that the civil, family and traffic divisions of the court experienced the down turn in on-time case processing that ultimately resulted in the decrease of the CPI.

From the GUI, then, the user can learn a number of different pieces of information related to the court, and performance of the court, including trends over time, the alignment of the court's performance with management processes such as strategic planning, budgeting, quality improvement, and employee evaluation. Additionally, the user can learn information regarding related measures, and best practices in the performance area gauged by the measures. Thus, in a few minutes, the user will have had opportunities to view the performance “dashboard” or “scorecard,” determine the day's “score,” quickly ascertain trends, control levels, identify potential problem areas, and decide what needs to be done. In this example, the court manager, judge or other employee may decide to focus on the on-time case processing of the civil, family and/or traffic divisions within the court to thereby improve overall performance of the court, which may be represented by the CPI.

According to one aspect of the present invention, all or a portion of the system 10 of the present invention, such as all or portions of the information provider(s) 12, service provider(s) 14 and/or client(s) 16 generally operates under control of a computer program product (e.g., applications 30). For example, the GUI may be constructed and interactively viewed under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 3 is a flowchart of methods, systems and program products according to embodiments of the present invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of block(s) or step(s) in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system comprising:
a memory for storing at least one database including information related to an organization, at least one performance measure and a performance composite, wherein at least one performance measure is associated with a value calculated based upon the organization information, wherein the performance composite is associated with a value calculated based upon the at least one performance measure value; and
a processing element capable of generating a graphical user interface (GUI) that includes the organization information, at least one performance measure and performance composite, wherein the included organization information, at least one performance measure and performance composite comprise elements of an information hierarchy, each element of the information hierarchy being associated with at least one of at least one ascendant element, at least one sibling element and at least one descendant element, and wherein the processing element is capable of generating the GUI such that:
a first portion of the GUI presents a selected element, and at least one of identifies and presents at least one sibling element of the selected element when the selected element is associated with at least one sibling element,
a second portion of the GUI at least one of identifies and presents at least one ascendant element of the selected element when the selected element is associated with at least one ascendant element, and
a third portion of the GUI at least one of identifies and presents at least one descendant element of the selected element when the selected element is associated with at least one descendant element.

2. A system according to claim 1, wherein the processing element is capable of generating the GUI such that the first portion of the GUI identifies the selected element and includes at least one of a value associated with the selected element, a change in the value associated with the selected element, and a symbol indicating if the value associated with the selected element has experienced a change.

3. A system according to claim 2, wherein the processing element is capable of generating the GUI such that the first portion of the GUI further includes at least one of a graphical representation of the value associated with the selected element over a period of time, and a description of the selected element.

4. A system according to claim 1, wherein the processing element is capable of generating the GUI such that the second portion of the GUI identifies at least one ascendant element of the selected element and, for each identified ascendant element, includes at least one of a value associated with the ascendant element, a change in the value associated with the ascendant element, and a symbol indicating if the value associated with the ascendant element has experienced a change.

5. A system according to claim 1, wherein the processing element is capable of generating the GUI such that the third portion of the GUI identifies at least one descendant element of the selected element and, for each identified descendant element, includes at least one of a value associated with the descendant element, a change in the value associated with the descendant element, and a symbol indicating if the value associated with the descendant element has experienced a change.

6. A system according to claim 5, wherein the processing element is capable of generating the GUI such that the third portion of the GUI further includes, for at least one selected descendant element, at least one of a graphical representation of the value associated with the selected descendant element over a period of time, and a description of the selected descendant element.

7. A system according to claim 1, wherein the processing element is further capable of receiving the organization information, calculating the at least one performance measure value based upon the organization information, and calculating the quantitative performance composite value based upon the at least one performance measure value.

8. A system according to claim 7, wherein the processing element is capable of calculating the performance composite value by weighting at least one performance measure value by an associated weighting factor, and thereafter aggregating the at least one performance measure value including the weighted at least one performance measure value into the performance composite value.

9. A system according to claim 7, wherein the at least one database includes information related to a judicial court organization, wherein the processing element is capable of calculating at least one performance measure value related to performance of the court, and wherein the processing element is capable of calculating a performance composite value related to an aggregate performance of the court.

10. A system according to claim 9, wherein a plurality of cases are before the court including cases at least one of scheduled for and disposed by the court, and
wherein the processing element is capable of calculating at least one core performance measure value related to at least one of opinions of those persons associated with cases before the court, opinions of employees of the court, a cost per case before the court, a case record reliability, juror representation, restitution payments ordered by the court, and caseflow timeliness and efficiency.

11. A system according to claim 10, wherein the processing element is capable of calculating a performance measure value related to caseflow timeliness and efficiency by calculating at least one secondary performance measure value related to at least one of on-time case processing, case clearance, backlog clearance, and trial-date certainty, and thereafter aggregating the at least one secondary performance measure value into the performance measure value related to caseflow timeliness and efficiency.

12. A system according to claim 11, wherein the processing element is further capable of weighting at least one secondary performance measure value by an associated weighting factor, and wherein the processing element is capable of aggregating the at least one secondary performance measure value including the weighted at least one secondary performance measure value into the performance measure value related to caseflow timeliness and efficiency.

13. A computer-implemented method comprising:
generating a graphical user interface (GUI) that includes information related to an organization, at least one performance measure and a performance composite, wherein the at least one performance measure is associated with a value calculated based upon the organization information, wherein the performance composite is associated with a value calculated based upon the at least one performance measure value,
wherein the included organization information, at least one performance measure and performance composite comprise elements of an information hierarchy, each element of the information hierarchy being associated with at least one of at least one ascendant element, at least one sibling element and at least one descendant element, and wherein the GUI is generated such that:
a first portion of the GUI presents a selected element, and at least one of identifies and presents at least one sibling element of the selected element when the selected element is associated with at least one sibling element,
a second portion of the GUI at least one of identifies and presents at least one ascendant element of the selected element when the selected element is associated with at least one ascendant element, and
a third portion of the GUI at least one of identifies and presents at least one descendant element of the selected element when the selected element is associated with at least one descendant element.

14. A method according to claim 13, wherein generating a GUI comprises generating a GUI such that the first portion of the GUI identifies the selected element and includes at least one of a value associated with the selected element, a change in the value associated with the selected element, and a symbol indicating if the value associated with the selected element has experienced a change.

15. A method according to claim 14, wherein generating a GUI comprises generating a GUI such that the first portion of the GUI further includes at least one of a graphical representation of the value associated with the selected element over a period of time, and a description of the selected element.

16. A method according to claim 13, wherein generating a GUI comprises generating a GUI such that the second portion of the GUI identifies at least one ascendant element of the selected element and, for each identified ascendant element, includes at least one of a value associated with the ascendant element, a change in the value associated with the ascendant element, and a symbol indicating if the value associated with the ascendant element has experienced a change.

17. A method according to claim 13, wherein generating a GUI comprises generating a GUI such that the third portion of the GUI identifies at least one descendant element of the selected element and, for each identified descendant element, includes at least one of a value associated with the descendant element, a change in the value associated with the descendant element, and a symbol indicating if the value associated with the descendant element has experienced a change.

18. A method according to claim 17, wherein generating a GUI comprises generating a GUI such that the third portion of the GUI further includes, for at least one selected descendant element, at least one of a graphical representation of the value associated with the selected descendant element over a period of time, and a description of the selected descendant element.

18. A method according to claim 13 further comprising:
receiving the organization information;
calculating the at least one performance measure value based upon the organization information; and
calculating the quantitative performance composite value based upon the at least one performance measure value.

19. A method according to claim 18, wherein calculating the performance composite value comprises:
weighting at least one performance measure value by an associated weighting factor; and
aggregating the at least one performance measure value including the weighted at least one performance measure value into the performance composite value.

20. A method according to claim 18, wherein receiving the organization information comprises receiving information related to a judicial court organization,
wherein calculating the at least one performance measure value comprises calculating at least one performance measure value related to performance of the court, and
wherein calculating the performance composite value comprises calculating a performance composite value related to an aggregate performance of the court.

21. A method according to claim 20, wherein a plurality of cases are before the court including cases at least one of scheduled for and disposed by the court, and
wherein calculating the at least one performance measure value comprises calculating at least one core performance measure value related to at least one of opinions of those persons associated with cases before the court, opinions of employees of the court, a cost per case before the court, a case record reliability, juror representation, restitution payments ordered by the court, and caseflow timeliness and efficiency.

22. A method according to claim 21, wherein calculating a performance measure value related to caseflow timeliness and efficiency comprises:
calculating at least one secondary performance measure value related to at least one of on-time case processing, case clearance, backlog clearance, and trial-date certainty; and
aggregating the at least one secondary performance measure value into the performance measure value related to caseflow timeliness and efficiency.

23. A method according to claim 22, wherein calculating a performance measure value related to caseflow timeliness and efficiency further comprises weighting at least one secondary performance measure value by an associated weighting factor, and
wherein aggregating the at least one secondary performance measure value comprises aggregating the at least one secondary performance measure value including the weighted at least one secondary performance measure value.

24. A computer program product comprising at least one computer-readable storage medium having computer-readable program code portions stored therein, the computer-readable program code portions comprising:
a first executable portion for generating a graphical user interface (GUI) that includes information related to an organization, at least one performance measure and a performance composite, wherein the at least one performance measure is associated with a value calculated based upon the organization information, wherein the performance composite is associated with a value calculated based upon the at least one performance measure value,
wherein the included organization information, at least one performance measure and performance composite comprise elements of an information hierarchy, each element of the information hierarchy being associated with at least one of at least one ascendant element, at least one sibling element and at least one descendant element, and wherein the first executable portion is adapted to generate the GUI such that:
a first portion of the GUI presents a selected element, and at least one of identifies and presents at least one sibling element of the selected element when the selected element is associated with at least one sibling element,
a second portion of the GUI at least one of identifies and presents at least one ascendant element of the selected element when the selected element is associated with at least one ascendant element, and
a third portion of the GUI at least one of identifies and presents at least one descendant element of the selected element when the selected element is associated with at least one descendant element.

25. A computer program product according to claim 24, wherein the first executable portion is adapted to generate a GUI such that the first portion of the GUI identifies the selected element and includes at least one of a value associated with the selected element, a change in the value associated with the selected element, and a symbol indicating if the value associated with the selected element has experienced a change.

26. A computer program product according to claim 25, wherein the first executable portion is adapted to generate a GUI such that the first portion of the GUI further includes at least one of a graphical representation of the value associated with the selected element over a period of time, and a description of the selected element.

27. A computer program product according to claim 24, wherein the first executable portion is adapted to generate a GUI such that the second portion of the GUI identifies at least one ascendant element of the selected element and, for each identified ascendant element, includes at least one of a value associated with the ascendant element, a change in the value associated with the ascendant element, and a symbol indicating if the value associated with the ascendant element has experienced a change.

28. A computer program product according to claim 24, wherein the first executable portion is adapted to generate a GUI such that the third portion of the GUI identifies at least one descendant element of the selected element and, for each identified descendant element, includes at least one of a value associated with the descendant element, a change in the value associated with the descendant element, and a symbol indicating if the value associated with the descendant element has experienced a change.

29. A computer program product according to claim 28, wherein the first executable portion is adapted to generate a GUI such that the third portion of the GUI further includes, for at least one selected descendant element, at least one of a graphical representation of the value associated with the selected descendant element over a period of time, and a description of the selected descendant element.

30. A computer program product according to claim 24 further comprising:
a second executable portion for receiving the organization information;
a third executable portion for calculating the at least one performance measure value based upon the organization information; and
a fourth executable portion for calculating the quantitative performance composite value based upon the at least one performance measure value.

31. A computer program product according to claim 30, wherein the fourth executable portion is adapted to calculate the performance composite value by:
weighting at least one performance measure value by an associated weighting factor; and
aggregating the at least one performance measure value including the weighted at least one performance measure value into the performance composite value.

32. A computer program product according to claim 30, wherein the second executable portion is adapted to receive information related to a judicial court organization,
wherein the third executable portion is adapted to calculate at least one performance measure value related to performance of the court, and
wherein the fourth executable portion is adapted to calculate a performance composite value related to an aggregate performance of the court.

33. A computer program product according to claim 32, wherein a plurality of cases are before the court including cases at least one of scheduled for and disposed by the court, and
wherein the third executable portion is adapted to calculate at least one core performance measure value related to at least one of opinions of those persons associated with cases before the court, opinions of employees of the court, a cost per case before the court, a case record reliability, juror representation, restitution payments ordered by the court, and caseflow timeliness and efficiency.

34. A computer program product according to claim 33, wherein the third executable portion is adapted to calculate a performance measure value related to caseflow timeliness and efficiency by:
calculating at least one secondary performance measure value related to at least one of on-time case processing, case clearance, backlog clearance, and trial-date certainty; and
aggregating the at least one secondary performance measure value into the performance measure value related to caseflow timeliness and efficiency.

35. A computer program product according to claim 34, wherein the third executable portion is further adapted to weight at least one secondary performance measure value by an associated weighting factor such that the third executable portion aggregates the at least one secondary performance measure value including the weighted at least one secondary performance measure value.
